(19) United States
(12) Patent Application Publication
(10) Pub. No.: US 2023/0316430 A1
(43) Pub. Date: Oct. 5, 2023

(54) SOCIAL MEDIA CONTENT CREATION AND AUTOMATION DISTRIBUTION

(71) Applicant: Anthem Business Software, LLC, Orlando, FL (US)

(72) Inventors: Adam DeGraide, Windermere, FL (US); Joe Amaral, Eustis, FL (US)

(73) Assignee: Anthem Business Software, LLC, Orlando, FL (US)

(21) Appl. No.: 18/193,484

(22) Filed: Mar. 30, 2023

Related U.S. Application Data
(60) Provisional application No. 63/326,301, filed on Apr. 1, 2022.

(51) Int. Cl. G06Q 50/00; G06F 9/54

(52) U.S. Cl. CPC G06Q 50/01; G06F 9/547

(57) ABSTRACT

The present invention automatically creates content for social media posts and then adds the automatically created content to a stored library of social media content. The content is scheduled for posting as social media posts for distribution on a predefined schedule (i.e., once a day, twice a day, once a week, three times a week, and the like). Then, at the selected times and schedule, the created social media content is posted. As a result, the software, system, and method of the present invention effectively and affordably carries out such content creation and distribution.

### CROSS REFERENCE TO RELATED APPLICATION

This application is related to, and claims benefit from, earlier filed U.S. Provisional Application No. 63/326,301, filed Apr. 1, 2022, entitled “SOCIAL MEDIA CONTENT CREATION AND AUTOMATION DISTRIBUTION,” incorporated herein its entirety.

### BACKGROUND OF THE INVENTION

The invention relates generally to software, will be used in any business of any size and in any industry for the use of Marketing. More specifically, the present invention relates to the curation, creation and posting of social media posts.

In the computer, Internet and social media industries, creation of social media content for posting to a given social media platform is very common. However, there are many challenges associated with the current process for creating and posting such social media content.

Companies are always looking to increase traffic to their website and posting to social media is helpful in support of that effort, as is very well known in the industry. However, it takes time and cost to curate social media posts. For example, there is significant cost associated with this process for the salary of employees, contractors, and software, for example, in connection with curating such social media post(s) either by hiring a company or an employee to do the curating.

There are also problems associated with manual posting of social media posts. For example, manual posts can suffer from inaccuracy due to human error to create entity specific content for distribution on Social Media platforms. Common human errors may include grammatical errors, spelling errors, choosing the wrong pictures to include in the social media posts, forgetting to post and/or many other types of human-related errors.

There have been attempts by others to address the foregoing problems. For example, there are other content distribution companies such as Hootsuite, Sprout Social, and Buffer app, which allow the manual creation and distribution of content along social media platforms. However, the process is still manual, and the content needs to be curated by a human author or content writer. Using these software applications requires a cost paid to the application company to use their software as well as the cost of time/employment to have these post(s) created and scheduled. Also, many times the posts created on these platforms do not drive traffic to the intended websites to benefit the company that is using the software for social media posting. Therefore, these prior attempts still fail to fully address the above problems associated with creating and posting social media content.

Therefore, there is a need in the industry for software that can effectively and affordably create content and distribute it on a timed schedule for any business using this invention/software.

There is a need for software and a system that reduces the level of human interaction to reduce or eliminate errors in social media content.

### SUMMARY OF THE INVENTION

The present invention preserves the advantages of prior art software, systems, and methods of creating and posting social media content. The software, system and method of the present invention curates the content from existing sources, such as user specified uniform resource locators (URLs) already attributable to the entity using structured data relevant for constructing social media posts. The software looks for specific content types on user provided website URL(s) and automatically creates post(s) based on the available content on the provided website, stores the created post(s) and then distributes the created post(s) on a predefined posting schedule.

Therefore, the present invention 1) automatically creates content for social media posts, 2) adds the automatically created content to a stored library of social media content, and 3) scheduling the social media posts for distribution on a predefined schedule (i.e., once a day, twice a day, once a week, three times a week, and the like).

Therefore, an object of the present invention is to provide software, system and a method that can effectively and affordably create content and distribute it on a timed schedule for any business using this invention/software.

A further object of the present invention is to provide software, a system and method that reduces the level of human interaction to reduce or eliminate errors in social media content.

### BRIEF DESCRIPTION OF THE DRAWING FIGURES

The novel features which are characteristic of the present invention are set forth in the appended claims. However, the invention's preferred embodiments, together with further objects and attendant advantages, will be best understood by reference to the following detailed description taken in connection with the accompanying drawings in which:

FIG. 1 is a screenshot of where a user connects social media accounts and chooses a defined posting schedule to the social media accounts;

FIG. 2 is a screenshot of the campaign dashboard;

FIG. 3 is a screenshot of where the user can add additional URLs to pull content from for

their social media post(s) creation;

FIG. 4 is a screenshot of where the user will import a URL for the software to go find URL

pages to create posts from;

FIG. 5 is a screenshot of a sample post that would be created from a URL taken from a user specified website and also through the Create a Post Button;

FIG. 6 is a screenshot of what the software finds when a URL is entered in. It finds all pages that can be used for a post(s), defines them in regard to whether a post can be created or not based on the page data. Users then can go and view the automatically created post(s) and choose to either add them to their library for future posting or not.

FIG. 7 is a flow chart showing the general workflow wire frame of the present invention;

FIGS. 8A-C are flow charts showing the social module in accordance with the present invention;

FIG. 9 shows a flow chart of the linking social media module;

FIG. 10 shows a flow chart of the website scraping process in accordance with the present invention;

FIG. 11 shows an example website for scraping in accordance with the present invention;

FIGS. 12A-C show the portions of HTML code, such as image, title, description, tag, for scraping and extraction for use to build the social media post; and

FIGS. 13A, 13B show what a generated social media post looks like as generated from the example website shown in FIG. 11.

### DESCRIPTION OF THE INVENTION

To address the known problem of the continuous need of content to be created and distributed to social media platforms, the software, system and method of the present invention creates and curates large amounts of content for social media distribution, which solves the time and money problems associated with curating large amounts of social media posts for a given entity's marketing program. The present invention stores past and future content post(s) to distribute and redistribute across social media platform(s). By having social media post(s) stored in a large library it solves time and cost issues associated with continuous curation and distribution of future social media post(s). It is not possible to carry out the present invention by hand or manually because automated computer equipment is required to carry out the curation of the social media posts in order for the results to be effective useful.

The present invention also helps drive more traffic to the entity's website. This is carried out by the software adding links to the user provided URL in every post which will help direct more traffic/clicks to an entity's website.

The present invention reduces human involvement in the social media content creation and posting processes to reduce cost, such as employment cost. The software automates distribution of stored content on a timely or scheduled basis which solves cost and time issues associated with having to manually schedule social media post(s) for future distribution. Moreover, it is not possible to carry out the present invention by hand or manually because computer equipment and software thereon is required to carry out the curation of the social media posts in order for the results to be effective, useful, and accurate. As a result, it is possible to carry out the present invention, as claimed herein, with only human involvement.

Further, the present invention reduces the amount of human error in social media posts by utilizing existing proofed content on user provided website URL(s) and by leveraging grammatical and spell-checking algorithms. Again, it is not possible to carry out this step of the present by human action. It is only possible using the method and system of the present invention.

The foregoing is a significant advance over known manual content creation, content management and content posting.

To carry out the objects of the present invention, the software, system, and method of the present invention takes an existing website URL link, provided by the user, and searches the whole site for structured content to be automatically created into multiple social media post(s). Each page on a website becomes linkable social media post(s) with written content taken from the website page as well as the image on the page used for the social media post(s). Each post links back to the URL used to originally create the post thereby generating more traffic back to the entity's website. After content post(s) are created by software, those post(s) are then stored in a social media library that is used for current and future posting. Then, the social media post(s) are scheduled to automatically distribute/post the created content to selected and connected social media platform(s) based on preset scheduling time(s). The created post(s) may be altered once created by the software if the user chooses to do so manually.

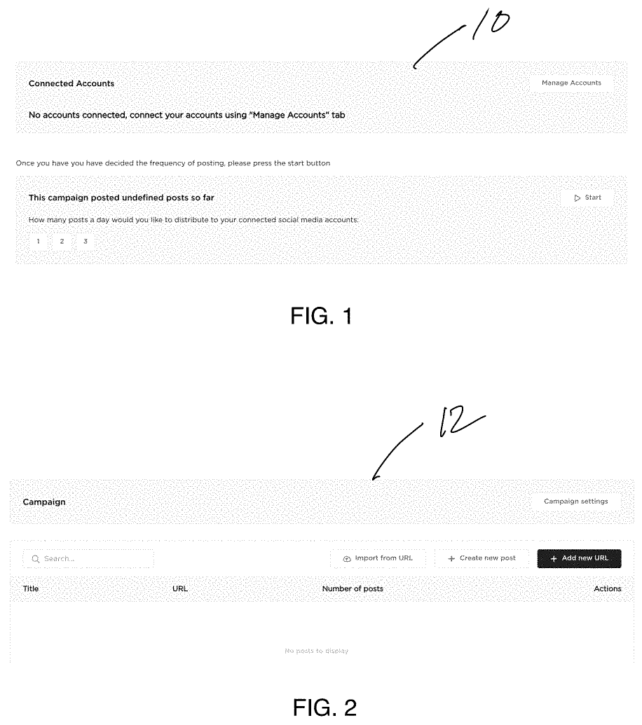

The software, system and method of the present invention is preferably a cloud-based application where users sign up and create an account within the application and then the user would be asked to connect to a user-chosen social media platform(s) to properly use the application. Turning first to FIG. 1, a screenshot of such sign up screen 10 is shown where a user connects social media accounts and chooses a defined posting schedule to such social media accounts. The user will then be asked to define a distribution schedule for future postings, as also shown in FIG. 1.

Once the user has created a profile, chosen a posting schedule, and connected their chosen social media platform(s), then, as in FIGS. 2-4, the user automates the curation of content by inserting a URL(s) in the application where the URL can be entered/provided in different ways. This automation achieves curation of content that is not possible by human or manual selection. More specifically, the application then scans structured data on the given URL(s) and construct social media postings to be stored for social media distribution on the selected connected social media platforms and on the preset schedule that was chosen in the setup of the software.

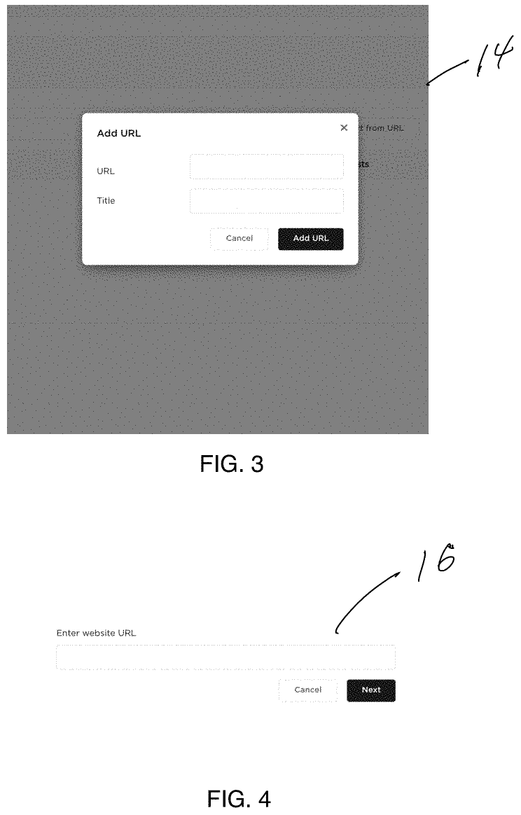

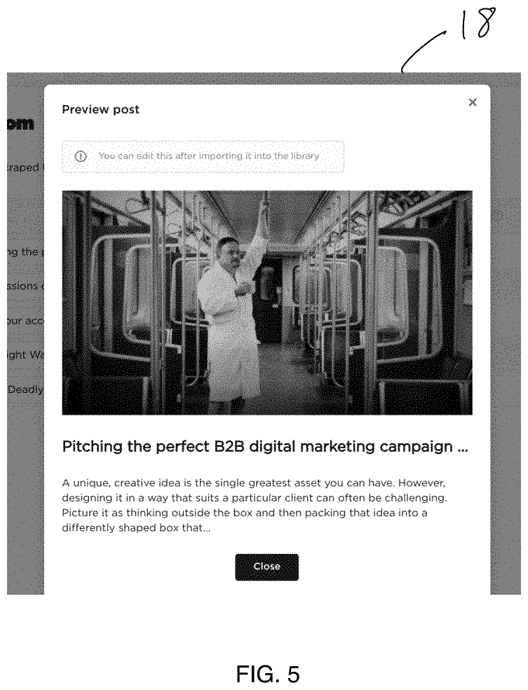

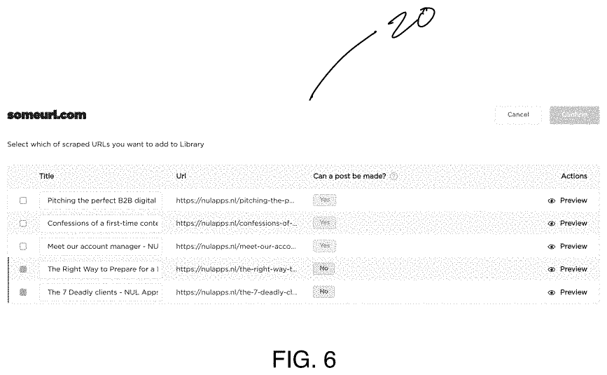

FIG. 2 shows an image of a given campaign dashboard 12 while FIG. 3 shows a screenshot of an input screen 14 where the user adds additional URLs to pull content from for their social media post(s) creation. Still further, as a next step, FIG. 4 shows a screenshot of an input screen 16 where the user will import a URL for the software to go find URL pages from which to create posts. Turning now to FIG. 5, a screenshot of a sample post 18 that would be created from a URL taken from a user specified website and can be achieved through a “Create a Post” button. Such a display of a screenshot of a sample post cannot be carried out by a person or manually and requires the use of a computer and the method and system of the present invention to be properly carried out. Thus, the screenshot of a FIG. 5 is a sample post 18 for review by the user. Next, FIG. 6 shows a screenshot of the results screen 20 what the software finds when a URL is entered in. It is not possible for such a screenshot to be displayed without the method and system of the present invention. In particular, it finds all pages that can be used for a given post(s), defines them in regards to whether a post can be created or not based on the page data. Users then can go and view the automatically created post(s) and choose to either add them to their library for future posting or not. Thus, FIG. 6 shows a screenshot of the screen 20 what the software of the present invention finds when a URL is entered.

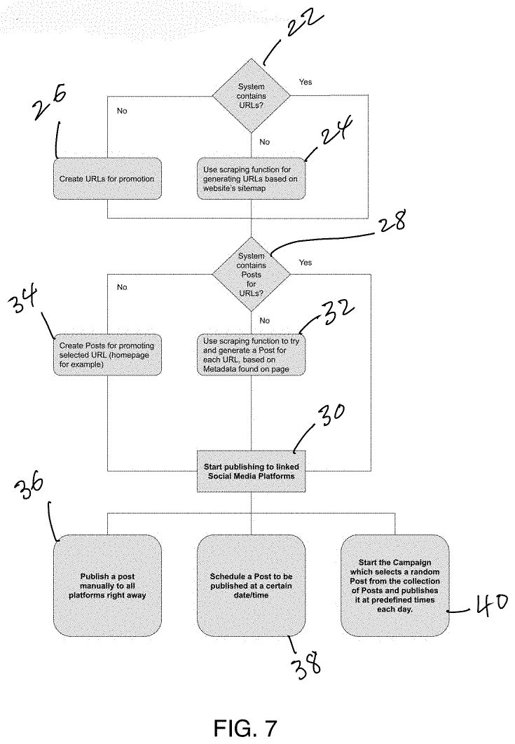

FIG. 7 shows the new and novel general workflow wire frame of the software, method and system of the present invention. More specifically, the method and system determines if the system contains any URLs at 22. If it does not, it can use a scraping function for generating URLs based on a website's sitemap at 24 or it can create URLs for promotion at 26. If it does contain URLs, the next step is to determine if the system contains posts for URLs at 28. If it does, the method starts publishing to linked social media platforms at 30. If the system does not contain posts for URLs, then the method can use a scraping function at 32 to try and generate a post for each URL, based on metadata found on a page. Post can be created as well at 34 for promoting a selected URL, such as a homepage. Upon publication, a post can be published manually at 36, a post can be scheduled to be published at a certain date and time at 38, and/or the campaign can be started which selects a random post from the collection of posts and publishes it at predefined times each day at 40. Thus, details of the scraping of the HTML code, creation function, and publication operation are shown.

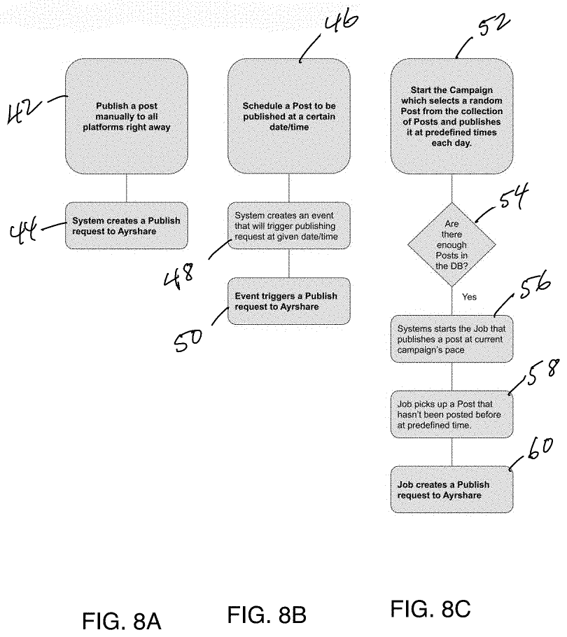

FIGS. 8A-C show an Ayrshare social module, as an example, that provides different options for posting created content, scheduling posting and campaign options in accordance with the present invention. Such module can include social media APIs. For example, as in FIG. 8A, a post can be published manually at 42 to all platforms right away where the system and method of the present invention creates a publish request to Ayrshare at 44. In FIG. 8B, a post can be scheduled to be published at a certain date and time at 46 where the system and method of the present invention creates an event that will trigger a publishing request at a given date and time at 48. Such an event them triggers a publish request to the social module, such as Ayrshare, at 50. Still further, FIG. 8C shows a start of a campaign which selects a random post from the collection of post and publishes it at predefined times each day at 52. If there are enough posts in the database collection of posts at 54, the method and system of the present invention starts the job that publishes a post at the current campaign's pace at 56, which may be predetermined. Then, the job picks up a post that hasn't been posted before at a predetermined date and time at 58. Finally, the job creates a publish request to Ayrshare at 60. Therefore, FIG. 8C is yet another example of how the method and system of the present invention is required where the posts must be stored and selected, which is cannot be carried out by a human alone.

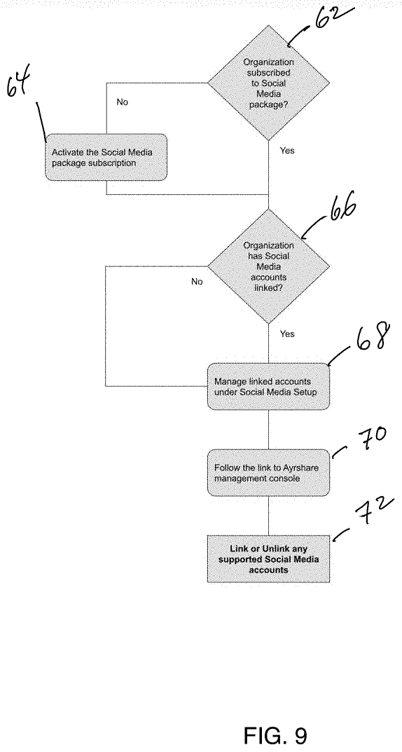

FIG. 9 shows a linking social media module that provides additional account management. If the organization is not subscribed to a social media package at 62, then the social media package subscription is activated at 64. Once the organization is subscribed to a social media package, the method and system determines whether the organization has social media accounts linked at 66. If not, the social media accounts are managed under Social Media setup at 68. Next, the link is followed to the Ayrshare management console at 70 where supported social media accounts may be linked or unlinked at 72.

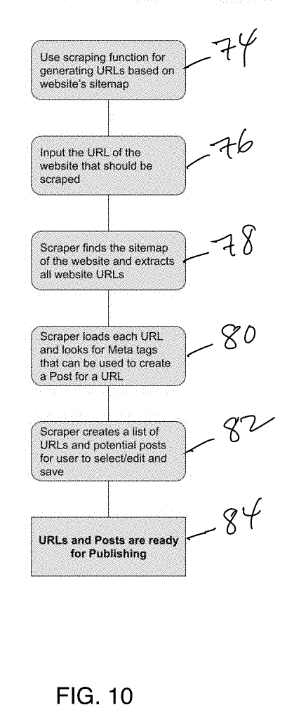

FIG. 10 shows an overview flow chart that provides details of the website scraping in accordance with the present invention. Such a step of the present invention is only possible with the method and system of the present invention as this cannot be carried out manually by a user. A scraping function generates URLs based on a website's sitemap at 74. Then, the URL of the website that should be scraped is inputted at 76. Next, the scraper finds the sitemap of the website and then extracts all website URLs at 78. The scraper then loads each URL and looks for meta tags that can be used to create a post for a URL at 80. Next, the scraper creates a list of URLs and potential posts for the user to select and/or edit and then save at 82. Thereafter, the URLs and posts are ready for publishing at 84. Therefore, in accordance with the present invention of FIG. 10, an automatically created social media post in accordance with the present invention preferably includes: 1) a picture from the selected website URL that the post(s) is being created from; 2) wording/content/text taken from the website URL that the post(s) is being created from; and 3) a link to the entity's website URL that the post is being created from thereby creating more traffic to the entity's website by facilitating a person viewing the social media post to find and click on a link back to the entity's website.

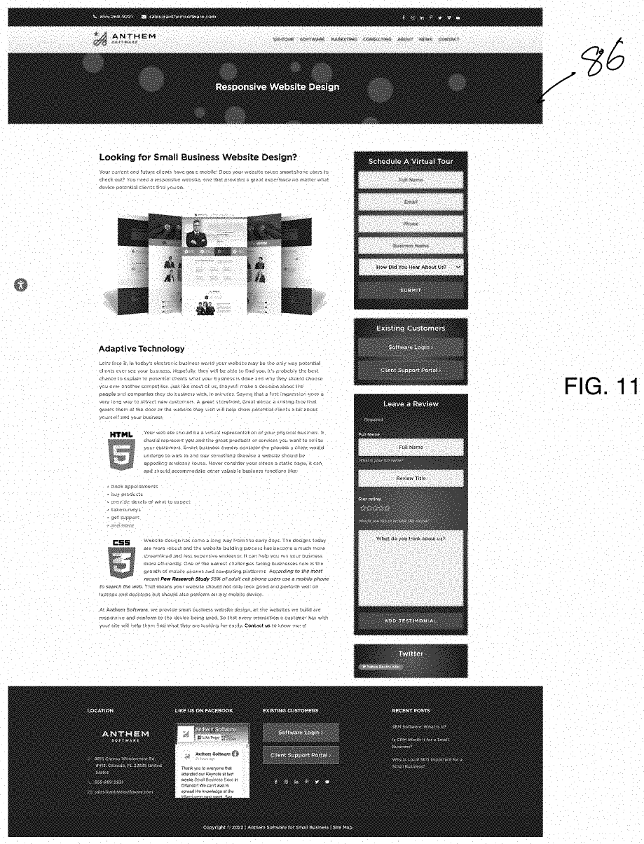

FIG. 11 shows a screenshot of the full web page 86 of one of the scraped URLs in question. For example, the URL https://anthemsoftware.com/web-development-and-design/is an example of such a scraped URL page. Therefore, FIG. 11 shows a screenshot of a webpage 86 from the URL that the user entered for creation of the social media post.

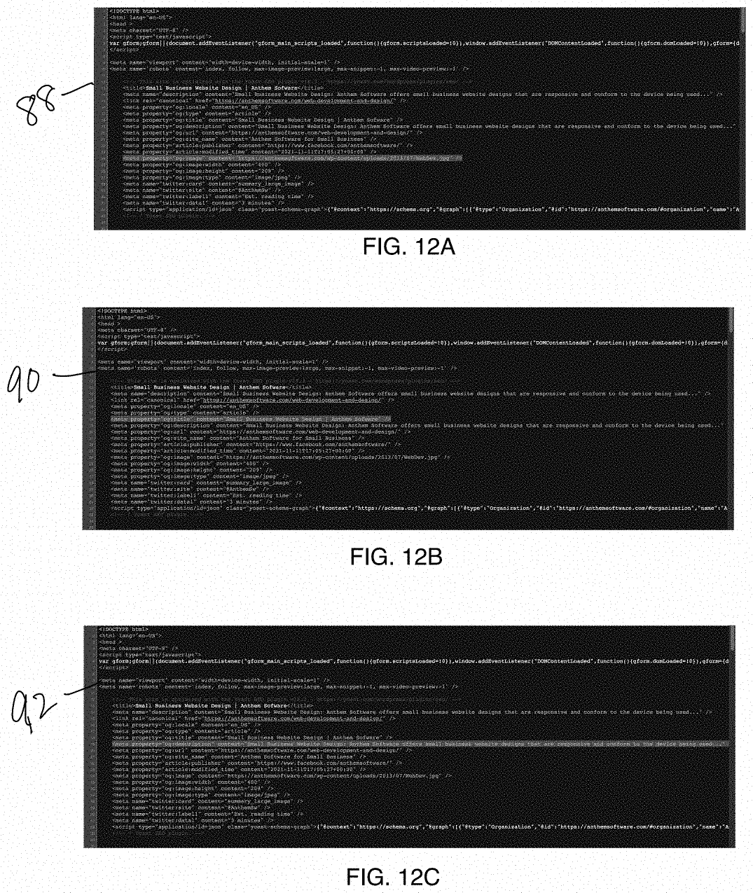

FIGS. 12A-C show an example of the software, system, and method of the present invention and how it automatically creates content for a social media post. FIGS. 12A-C show screenshots (reproduction) of the pertinent portion of the HTML code that the scraper will see and parse for purposes of building the post. Thus, the scraper loads the page 86 from FIG. 11 in the example above, loads the source code of the page (HTML/CSS), and starts looking for ‘meta’ HTML tags in order to extract the copy and use for post creation. As shown in FIGS. 12A-C, the scraper, for example, looks for image and title as well as description and site_name. More specifically, FIG. 12A shows an ‘og:image’ tag for post media 88. FIG. 12B shows ‘og:title’ tag for the post title 90. FIG. 12C shows the ‘og:description’ tag or ‘og:site_name’ as a fallback for post content 92. It should be noted that any HTML tagging or code structure can be used to target content within the application to locate and use in creating posts on websites and still be within the scope of the present invention. The example of FIGS. 12A-C above uses OpenGraph, as an example.

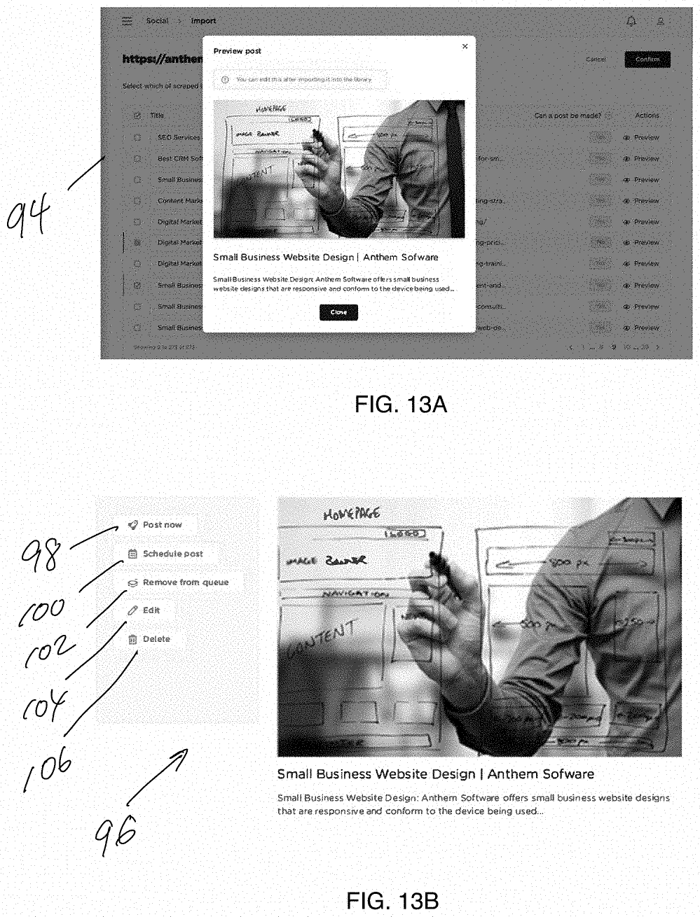

The present invention then uses the above scraped information to create the actual social media post, as seen in FIGS. 13A, B. FIG. 13A shows the post 94 in preview while FIG. 13B shows the post 96 and the options for acting on the post, such as to “Post now” 98, “Schedule post” 100, “Remove from queue” 102, “Edit” 104, and “Delete” 106. The image in the post can be different from the image on the actual page. This can be due to how the website defines the image associated with the page. In the example above in FIGS. 13A and 13B, the image used is found within the og:image (OpenGraph) tag, and that image is different from the image on the page: https://anthemsoftware.com/wp-content/uploads/2013/07/WebDev.jpg.

In summary, there is a full product pipeline of software that the software, system and method of the present invention may be used in. The UI/UX can be optimized to provide mobile responsiveness and can, optionally, provide Python and Django support. The Social Media Module (with proprietary, posting and data analytics) to create posts based on web pages and then schedule them to post them on social media sites, such as Facebook, Twitter, LinkedIn, Google My Business, Pinterest, Instagram. A reporting enhancement is also possible and envisioned with, for example, Google analytics, Google Search Console, Google Ads, Facebook Ads, Measurement of ROI by traffic source and sales.

Email Marketing Enhancements, such as using heavy automation, is envisioned in accordance with the present invention. For example, Sendgrid may be used to integrate email marketing for appointments, payment confirmations, payment collection, as well as email marketing, i.e., intent based campaigns.

Also, calls, texting, chat may be integrated into the present method and system of the present invention, such as by use of TWILIO. For example, chat could be a feature that would be external on the website and managed through the method and system of the present invention for reply and conversion to opportunity or appointment.

Moreover, calendar enhancement is also possible to integrate with an upgrade the existing calendar functionality where it would be envisioned to initiate consumer reminders noting service/product category, appointment type, salesperson assignment, as well as appointment duration.

Still further, integrated payment processing is envisioned where the current application uses, for example, Stripe and its many features. The present invention uniquely enables cross marketing of the user's services to their existing clients where the system can receive payments from such clients, such internally. Quickbooks, or other similar services, may be integrated into the method and system of the present invention where financial information is integrated into Quickbooks, or the like. Also, the following is envisioned: API Library (integration with other software); integration with third party marketing partners; Google (Analytics, Search Console, & Ads); Payroll & Timesheets to manage an input employee time tracking, manage and input payroll where the payment of electronic or paper checks could be carried out through Quickbooks, or the like; Inventory Management to be able to accept inventory and automatically deduct from a bill existing inventory; Memberships & Loyalty Rewards with the ability to create and manage memberships, such as (recurring payment for a service/product) or loyalty rewards (manage point issuance and redemption on future purchases); Packages with the ability to bundle service/products in a bulk sale at a discounted price; and Task management to create and manage tasks that need to be completed for a service/product to be completed. These could include communication internally or communication externally to the consumer.

It is also possible that Natural Language Processing (sentiment analysis) can be used to transcribe calls and read the customer service quality of the calls/emails to then then score a client on how well they are doing in serving their customers. AI/Machine Learning (suggestive learning for automation) may also be used to gather information on how users interact with the system and method of the present invention, the functions it performs, and build an engine that would predict what they should do next and either suggest or automate this. As an example, if it can be shown that automating follow up to a potential client through email & text with a specific discount increases ROI, a specific campaign could be suggested to do so.

Integrations of the present invention into other services are possible. For example, it is possible to integrate Canva into the present invention so users' can bring over images and video they create from Canva to the system of the present invention.

In view of the above, the present invention provides for the creation of the user's organization where a Social Module package subscription is purchased to the user can gain access to social tools section as described above. The user can link its website to the platform of the present invention so that platform can regularly scrape the content from the website. The user is able to link (i.e., authenticate) their social media accounts. The user of Ayrshare, as described above, is one example of other platforms that can be used by the present invention to, when connected to display the pages that have been connected to for later selection of the ones desired. The scraped content fills up a pool of posts that are made up of Page/Post title, Image, URL, and first number of characters on the page. The posts can also be manually added to the pool of posts. The user can manually share one of the posts to authenticated social media and can also create a schedule, as desired. In practice, once a user has an account, at an account level, they can connect their social media accounts and then set scheduling options, such as 1, 2, 3, or more, for example, posts per day.

Further options are envisioned. For example, a user can optionally connect their website (I/VP to start, then others via RSS feed). The system can scrape pages/posts and pull in the URL's, Page Titles, Featured Image, and the first 280 characters, for example, to provide sufficient information for a post to be created. Then, the new posts are created new posts (i.e. image & text, with the option to add those newly created messages to an existing page URL that has been pulled in). These newly created posts become part of a unique library of messages that are associated that page. Once there are enough messages (for example, a minimum of 30), a campaign can be activated to start sending various messages to the connected accounts in accordance with the previously chosen campaign schedule it is also possible that system and method of the present invention checks to ensure that it doesn't repost a given post within a certain amount of time or after a certain number of posts, such as in the last 5 posts.

It would be appreciated by those skilled in the art that various changes and modifications can be made to the illustrated embodiments without departing from the spirit of the present invention. All such modifications and changes are intended to be covered by the appended claims.

What is claimed is:

1. A method of posting social media content, comprising the steps of:
providing a computer with an Internet-connected webpage and associated URL;
scraping HTML code located as the associated URL looking for specific content types;
automatically creating social media content formatted content based on a content types from the scraped HTML page to generate a social media post;
storing the generated social media post; and
publishing the generated social media post on a predefined posting schedule to a social media platform.

2. The method of claim 1, wherein the social media content is structured content.

3. The method of claim 1, wherein each webpage is linkable social media post.

4. The method of claim 1, wherein the social media platform is selectable.

5. The method of claim 1, wherein the generated social media post is previewed prior to publication.

6. The method of claim 1, wherein, if the webpage contains no URLs, generating a post based on meta data on the webpage.

7. The method of claim 1, further comprising social media APIs to facilitate publication of a post.

8. The method of claim 1, wherein a plurality of posts are stored in a collection for selection therefrom for posting.

9. The method of claim 8, further comprising:
selecting one of the posts that has not been posted before at a predetermined date and time.

10. The method of claim 1, wherein the social media post includes an image from the selected website URL that the post is being created from, text taken from the website URL that the post is being created from, and a link to the website URL from which the post is being created.
